(19) United States
(12) Patent Application Publication
(10) Pub. No.: US 2004/0061009 A1
(43) Pub. Date: Apr. 1, 2004

(54) Scrap fragmenting apparatus

(76) Inventor: F. F. Rosser JR., Cordele, GA (US)

Correspondence Address: NIXON & VANDERHYE, PC, 1100 N GLEBE ROAD, 8TH FLOOR, ARLINGTON, VA, 22201-4714, US

(21) Appl. No.: 10/352,032

(22) Filed: Jan. 28, 2003

Related U.S. Application Data
(60) Provisional application No. 60/351,415, filed on Jan. 28, 2002.

(51) Int. Cl. B02C 21/02

(52) U.S. Cl. 241/101.76; 241/264

(57) ABSTRACT

Apparatus for fragmenting scrap materials, comprising a transportable platform and a fragmenter mounted on the platform for fragmenting scrap materials deposited therein. A first discharge conveyor is mounted on the platform for receiving fragmented scrap materials from the fragmenter. An inspection conveyor is mounted on the platform for receiving and sorting fragmented scrap materials from the first discharge conveyor. A second discharge conveyor is mounted on the platform for receiving fragmented and sorted scrap materials from the inspection conveyor and transporting them to a container or vehicle for recycling or disposal. The fragmenter comprises a fragmenter head mounted for reciprocating movement toward and away from an anvil for fragmenting scrap material positioned therebetween and enabling it to be discharged to the first discharge conveyor.

### CROSS REFERENCE TO RELATED APPLICATION

The present application incorporates the subject matter and claims the priority of Provisional Application Serial No. 60/351,415 filed on Jan. 28, 2002.

### BACKGROUND AND SUMMARY OF THE INVENTION

The present invention relates to the fragmenting or crushing of scrap materials, and more particularly, to a new and improved apparatus for fragmenting and processing scrap materials such as military ordnance.

Present methods of destruction of scrap such as military ordnance utilize a variety of scrap processing equipment including shredders, rock crushers, shears, torches and waterjet cutters. Some of these methods also involve the cryogenic treatment of the scrap material. For the most part, the present methods are costly and time-consuming.

The present invention has the following advantages over the previously used methods and apparatus for fragmenting scrap materials:

1. It is more efficient and cost-effective in the processing of scrap materials;

2. It is portable or transportable and thus facilitates the processing of scrap materials at their locations, such as bombing ranges and other remote locations;

3. It is capable of handling a variety of sizes and shapes of munitions and other scrap materials;

4. It is capable of being remotely controlled for safety purposes; and

5. It does not require the cryogenic treatment of the scrap material.

### SUMMARY OF THE INVENTION

The new and improved fragmenting apparatus of the present invention generally comprises a fragmenter, a first discharge conveyor, an inspection conveyor and a second or final discharge conveyor, all of which are mounted on a transportable support such as a flatbed wheeled trailer of suitable length, such as 50 feet. Accordingly, the fragmenting apparatus is readily transportable to a desired processing site. This feature is particularly advantageous in connection with the disposal of ordnance where it is desirable to avoid the transfer of the ordnance to a disposal site for safety purposes, and instead dispose of the scrap ordnance on the site where it is being stored.

In the operation of the fragmenting apparatus of the present invention, the scrap material to be processed is loaded into the fragmenter in any suitable manner, either manually or by a remotely operated loading device such as a crane. The fragmenter serves to fracture or compress the scrap material and expels the fractured scrap material through an opening in the bottom thereof to a first discharge conveyor that transports the material to the inspection conveyor. As the material is being transported on the inspection conveyor, it is inspected and separated into various classes of recyclable or disposable materials. Depending on the type of material being processed, the inspection and separation can be accomplished manually or by the use of remotely operated detection and separation devices. After inspection, the scrap material is transported by a second or final discharge conveyor into a container for transportation to a recycling or disposal site.

More specifically, in accordance with one embodiment of the invention, the fragmenter comprises an inlet opening at the upper end thereof through which the scrap material may be loaded into a loading chamber defined by a hopper wall on one side thereof and the upper wall of a pivotable fragmenter head disposed on the other side thereof. The lower portion of the fragmenter head is disposed in spaced relation to an anvil positioned beneath the hopper wall so that scrap material deposited in the loading chamber moves downwardly between the lower portion of the fragmenter head and the opposed anvil.

The fragmenter head is pivoted toward and away from the anvil in an oscillating or reciprocating motion by any suitable power device such as a hydraulic cylinder and piston device. As the fragmenter head is moved toward the anvil, the lowest scrap material in the loading chamber is trapped between the fragmenter head and the anvil. The continued movement of the fragmenter head toward the anvil serves to fragment the scrap material between it and the anvil as a result of the force created by the hydraulic cylinder and piston device. As the fragmenter head is moved away from the anvil, the fragmented scrap material therebetween falls downwardly through a discharge opening onto the first discharge conveyor.

The space between the fragmenter head and the anvil can be adjusted to accommodate different types of scrap material to be processed. Also, the continuous oscillating or reciprocating motion of the fragmenter head allows the scrap material to flow continuously through the fragmenter aided by gravity and the motion of the fragmenter head.

The apparatus of the present invention is advantageous in that the fragmenter can be used to fragment different types of scrap materials, such as cast iron projectiles or bombs, without a cryogenic treatment of the materials prior to fragmentation.

### BRIEF DESCRIPTION OF THE DRAWINGS

FIG. 1 is a is a side elevational view of the fragmenting apparatus of the present invention;

FIG. 2 is a top plan view of the fragmenting apparatus of the present invention;

FIG. 3 is a side elevational view, in section taken substantially along line 3-3 in FIG. 1, of one embodiment of a fragmenter in a first stage of operation wherein scrap material has been loaded therein for processing;

FIG. 4 is a view similar to FIG. 3 of the fragmenter in a second stage of operation wherein some of the scrap material loaded therein is being fragmented; and

FIG. 5 is a view similar to FIGS. 3 and 4 of the fragmenter in a third stage of operation wherein the fragmented scrap material is being discharged from the fragmenter through the lower portion thereof.

### DESCRIPTION OF THE PREFERRED EMBODIMENTS

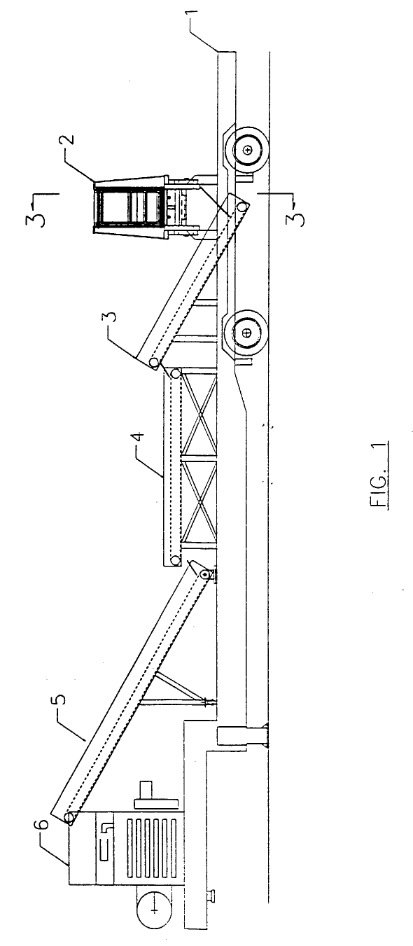

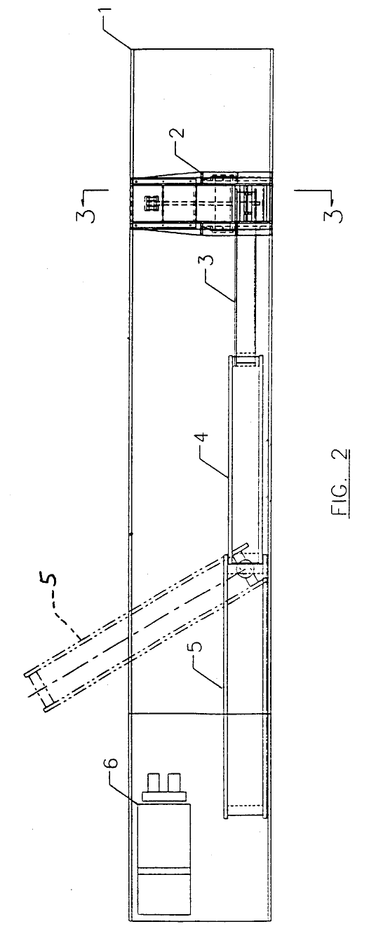

Referring to FIGS. 1 and 2, the fragmenting apparatus of the present invention generally comprises a fragmenter 2, a first discharge conveyor 3, an inspection conveyor 4, and a second or final discharge conveyor 5, all of which are mounted in general alignment on a transportable support 1, such as a flatbed wheeled trailer of suitable length, e.g., 50 ft. In this manner, the fragmenting apparatus can be readily transported to a desired processing site. This feature is particularly advantageous in connection with the disposal of military ordnance or the like where it is desirable to avoid the transfer of the ordnance to a disposal site for safety purposes, and instead dispose of the scrap ordnance on the site where it is being stored.

In the operation of the fragmenting apparatus, the scrap material 12 to be processed is loaded into the fragmenter 2 in any suitable manner, either manually or by a remotely operated loading device such as a crane (not shown). The fragmenter 2 serves to fracture or compress the scrap material 12 which falls through an opening in the bottom thereof to the first discharge conveyor 3 that transports the fractured material to the inspection conveyor 4. As the material is being transported on the inspection conveyor 4, it is inspected and separated into various classes of recyclable or disposable materials in any suitable manner. Depending on the type of fractured material being processed, the inspection and separation can be accomplished manually or by the use of remotely operated detection and separation devices (not shown). After inspection, the fractured scrap material is transported by the second or final discharge conveyor 5 into a container (not shown) for transportation to a recycling or disposal site.

A power unit 6 of any suitable type, such as a diesel powered unit, is mounted on the support 1 and is operatively connected to the fragmenter 2, first discharge conveyor 3, inspection and separation conveyor 4 and second or final discharge conveyor 5 in any suitable manner.

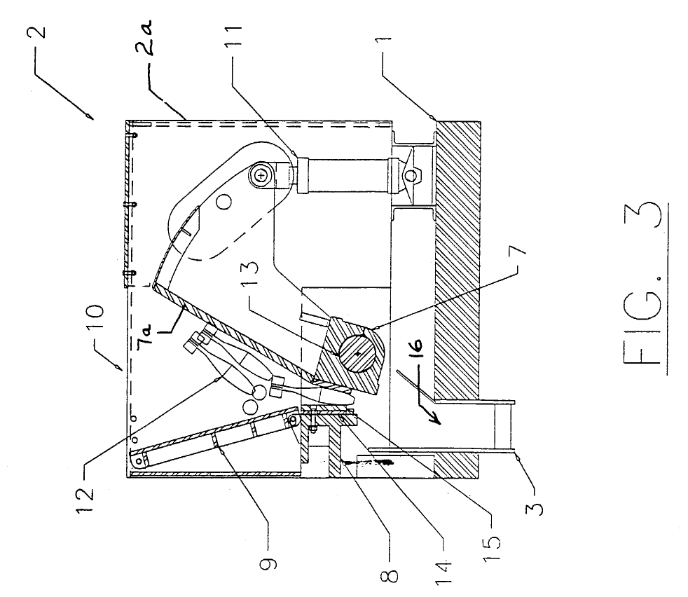

In accordance with one embodiment of the invention shown in FIGS. 3-5, the fragmenter 2 comprises a housing 2a having an inlet opening 10 in the upper end thereof through which the scrap material 12 may be loaded into a loading chamber defined by a hopper wall 9 on one side thereof and the upper wall 7a of a pivotable fragmenter head 7 disposed on the other side thereof. The fragmenter head 7 is pivotally mounted on the fragmenter 2 in any suitable manner, such as by a support pin 13.

The lower portion of the fragmenter head 7 is disposed in spaced relation to an anvil 8 positioned beneath the hopper wall 9 so that scrap material 12 deposited in the loading chamber of the fragmenter housing 2a moves downwardly between the lower portion of the fragmenter head 7 and the opposed anvil 8, as shown in FIG. 3. The space between the fragmenter head 7 and the anvil 8 can be adjusted to accommodate different types of scrap material 12 to be processed. For example, the anvil 8 may be provided with a face plate 15 removably secured thereto and spaced therefrom by one or more shims 14 to vary the spacing between the face plate 15 and the fragmenter head 7.

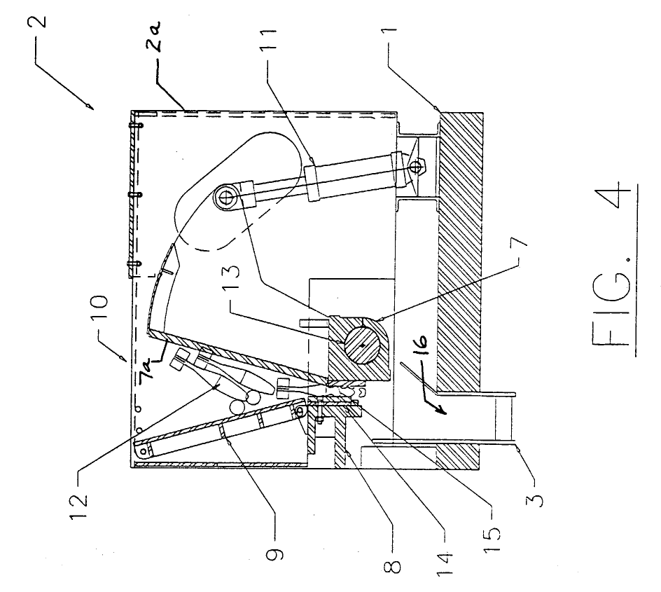

The fragmenter head 7 is pivoted toward and away from the anvil 8 in an oscillating or reciprocating motion by any suitable power device such as a hydraulic cylinder and piston device 11 connected to the upper portion of the fragmenter head. As the fragmenter head 7 is moved toward the anvil 8, the lowest scrap material 12 in the loading chamber is trapped between the fragmenter head 7 and the anvil 8. The continued movement of the fragmenter head 7 toward the anvil 8 serves to fragment the scrap material 12 between it and the anvil as a result of the force created by the hydraulic cylinder and piston device 11, as shown in FIG. 4.

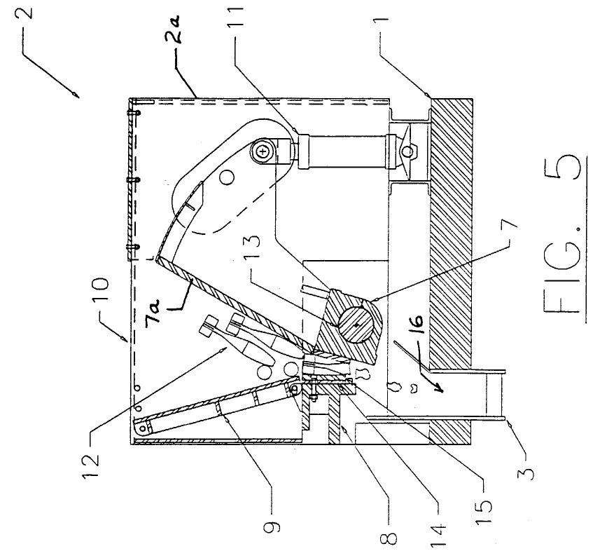

As the fragmenter head 7 is moved away from the anvil 8, the fragmented scrap material 12 therebetween falls downwardly through a discharge opening 16 in the housing 2a and onto the first discharge conveyor 3, as shown in FIG. 5. The continuous oscillating or reciprocating motion of the fragmenter head 7 allows the scrap material 12 to flow continuously through the fragmenter aided by gravity and the motion of the fragmenter head 7.

The fragmenter 2 and its components may be formed of any suitable strong material such as steel.

As shown in FIG. 2, the second or final discharge conveyor 5 may be pivotally or moveably mounted on the platform 1 so that it can be moved to the broken line position wherein it can deposit fragmented scrap material into a container (not shown) spaced from the platform 1 for transportation to a recycling or disposal site.

The fragmenting apparatus of the present invention is advantageous in that it can be used to fragment different types of scrap materials, such as cast iron projectiles or bombs, without a cryogenic treatment of the materials prior to fragmentation. Also, it is readily transportable to a desired processing site which is particularly desirable for the disposal of military ordnance or the like.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. Apparatus for fragmenting scrap materials, comprising:
a transportable platform;
a fragmenter mounted on said platform for fragmenting scrap materials deposited therein;
a first discharge conveyor mounted on said platform for receiving fragmented scrap materials from said fragmenter;
an inspection conveyor mounted on said platform for receiving and sorting fragmented scrap materials from said first discharge conveyor; and
a second discharge conveyor mounted on said platform for receiving fragmented scrap materials from said inspection conveyor and transporting them to a container for recycling or disposal.

2. The apparatus of claim 1 wherein the transportable platform is a flatbed wheeled trailer.

3. The apparatus of claim 1 wherein the fragmenter has an inlet opening in the upper portion thereof for receiving scrap materials and an outlet opening in the lower portion thereof for depositing fragmented scrap materials on said first discharge conveyor.

4. The apparatus of claim 1 wherein said second discharge conveyor is movably mounted on said platform to enable it to transport fragmented and sorted scrap materials to a container spaced from said platform.

5. The apparatus of claim 1, further comprising a power unit mounted on said platform and operatively connected to said fragmenter, said first discharge conveyor, said inspection conveyor and said second discharge conveyor.

6. The apparatus of claim 1 wherein said fragmenter comprises:
a housing having an upper inlet opening for receiving scrap materials and a lower outlet opening for discharging fragmented scrap materials;
a loading chamber in said housing defined by a hopper wall and the opposed upper portion of a fragmenter head disposed beneath said upper inlet opening, said fragmenter head being movably mounted on said housing;
an anvil mounted on said housing beneath said hopper wall in spaced relation to the lower portion of said fragmenter head to receive therebetween scrap materials deposited in said loading chamber; and
a power device connected to said fragmenter head for moving it in a reciprocating motion toward and away from said anvil to fragment scrap materials disposed therebetween and enable them to fall downwardly through said lower outlet opening for discharge onto said first discharge conveyor.

7. The apparatus of claim 6 wherein said fragmenter head is pivotally mounted on said housing.

8. The apparatus of claim 6 wherein said anvil is adjustable to vary the spacing between it and the lower portion of said fragmenter head to accommodate scrap materials of different sizes.

9. The apparatus of claim 8 wherein said anvil comprises a face plate that is removably and adjustably mounted thereon.

10. The apparatus of claim 9 wherein at least one shim is positioned between said anvil and said face plate.

11. The apparatus of claim 6 wherein said power device is a hydraulic cylinder and piston device.

12. The apparatus of claim 6 wherein the lower portion of said fragmenter head is pivotally mounted on said housing and said power device is connected to the upper portion of said fragmenter head.

13. A fragmenter for an apparatus for fragmenting scrap materials, said fragmenter comprising:
a housing having an upper inlet opening for receiving scrap materials and a lower outlet opening for discharging fragmented scrap materials;
a loading chamber in said housing defined by a hopper wall and the opposed upper portion of a fragmenter head disposed beneath said upper inlet opening, said fragmenter head being movably mounted on said housing;
an anvil mounted on said housing beneath said hopper wall in spaced relation to the lower portion of said fragmenter head to receive therebetween scrap materials deposited in said loading chamber; and
a power device connected to said fragmenter head for moving it in a reciprocating motion toward and away from said anvil to fragment scrap materials disposed therebetween and enable them to fall downwardly through said lower outlet opening.

14. The fragmenter of claim 13 wherein said fragmenter head is pivotally mounted on said housing.

15. The fragmenter of claim 13 wherein said anvil is adjustable to vary the spacing between it and the lower portion of said fragmenter head to accommodate scrap materials of different sizes.

16. The fragmenter of claim 15 wherein said anvil comprises a face plate that is removably and adjustably mounted thereon.

17. The fragmenter of claim 16 wherein at least one shim is positioned between said anvil and said face plate.

18. The fragmenter of claim 13 wherein said power device is a hydraulic cylinder and piston device.

19. The fragmenter of claim 13 wherein the lower portion of said fragmenter head is pivotally mounted on said housing and said power device is connected to the upper portion of said fragmenter head.
